(19) United States
(12) Patent Application Publication
(10) Pub. No.: US 2010/0062755 A1
(43) Pub. Date: Mar. 11, 2010

(54) Handling of Dynamic Neighbouring Cell Relations Using a TimeToLive Concept

(76) Inventor: John Quilty, Athlone (IE)

Correspondence Address: POTOMAC PATENT GROUP PLLC, P. O. BOX 270, FREDERICKSBURG, VA, 22404, US

(21) Appl. No.: 12/596,456

(22) PCT Filed: Apr. 20, 2007
(86) PCT No.: PCT/EP2007/053898

§ 371 Date: Oct. 19, 2009

(51) Int. Cl. H04M 3/00

(52) U.S. Cl. 455/418

(57) ABSTRACT

The present invention relates to a network element such as a base station controller, for a cellular network comprising one or more cells being served by at least one transceiver for enabling communication sessions with a mobile cellular terminal. The element comprises communication means adapted for communicating with other network nodes. The element further comprises register software adapted for creating, configuring and/or removing information about the cell on which a communication session is running and its relationship to at least one neighbouring cell to which a running communication session can be transferred and resource management software adapted for managing the communication session between the transceiver and the terminal. The element is further characterized in that the register software is adapted for creating and/or configuring a counter value on each relationship to a neighbouring cell, which value limits the time or number of events the neighbouring cell can be part of so that when the counter value corresponds to a removal value the relationship is removed.

### TECHNICAL FIELD

The present invention relates to a network element, such as a base station controller, for a cellular network comprising one or more cells being served by at least one transceiver for enabling communication sessions with a mobile cellular terminal. The element comprises communication means adapted for communicating with other network nodes within the same or other networks. The element further comprises register software adapted for creating, configuring and/or removing information about the cell on which a communication session is running and its relationship to at least one neighbouring cell to which a running communication session can be transferred and resource management software adapted for managing the communication session between the transceiver and the terminal. The present invention also relates to a method for handling neighbouring cell relationships for a network element and a cellular network.

### BACKGROUND

A cellular network is a radio-based network made up of a number of cells. Each cell exists in a geographical area covered/served by one or more transceivers, positioned in a base station. The cells together cover different areas to provide radio coverage over a wider area than that of one cell. The cellular network comprises a number of fixed main transceivers (on base stations) and a number of distributed mobile transceivers which provides services to the users of the network.

One common method for signal distribution between such transceivers (base stations and cell phones) is Time Division Multiple Access (TDMA), used in the GSM standard combined with Frequency Division Multiple Access (FDMA). Another common method is Code Division Multiple Access (CDMA) used for instance in 3G standards and Orthogonal Frequency Division Multiple Access (OFDMA) used in LTE and WiMAX. CDMA and OFDMA uses a wider frequency band to achieve the same transmission capacity. On the other hand, the frequency band can be used in all cells without any risk of interference. Since each mobile operator has one unique radio frequency band, these signal methods are essential for using the frequency band as much as possible. It is very common now to combine different methods to increase the capacity of the network.

The base station contains the transceivers, antennas and equipment for encrypting/decrypting communication with the base station controller (BSC) serving several base stations. In a UMTS (W-CDMA) the base station controller is known as the Radio Network Controller (RNC). Typically, the base station contains several transceivers to be able to serve several different frequencies within the band. The base stations serve/cover the different cells (geographical areas) of the cellular network and together build the complete network for a supplier. By using directional antennas on a single base station, each pointing in different directions, it is possible to sectorice the base station so that several different cells are served from the same location, using the same frequencies. This increases the traffic capacity of the base station whilst not greatly increasing the interference caused to neighboring cells.

The base/radio station controller is a network element in the network containing software to control and supervise a network or a network segment, a segment being a part of a network. The controller communicates with a large number of transceivers (either directly or through a communication device for a group of transceivers) and for instance controls handover and roaming. The controller keeps a record (list) of the external cells and keeps a geographical map (mapping) of which cells is its own cellular network that have relationship to those external cells, the so called neighbouring cells relationships. The relationship is held in the form of an object-oriented model. A local cell can have relationship with an external cell in its own kind of network or with an external cell in a different kind of network. Creating such a record (list) for a cell is complex and different algorithms are used together with input data from field measurements or computer predictions of radio wave propagation in the areas covered by the cells.

The neighbouring cells relationships are used in case of handover, which is the process for transferring ongoing communication sessions between a mobile phone and the network from one cell to another. Reasons for handover is for instance the mobile phone moving, lack of capacity within one cell, interference in case of FDMA/TDMA or changed moving behavior. Each cell in a cellular network is assigned a list of potential target cells for handover. These are the cells to which it has a neighbouring cell relationship. Roaming is the process when the handover of the communication session is made from its own cellular network to another mobile operator's cellular network. The two operators have an agreement that allows roaming and communication and subscription data is exchanged between their respective cellular networks when roaming. Roaming between networks of different technologies is a great challenge, and there are many standards in how to achieve interoperability between such networks.

The controller network element typically comprises management functionality. An operation and maintenance (O&M) network management system provides a package of network management functions for the operation of the cellular network. The functions refer to operation and maintenance of the network at a system level. Examples of such functions are hardware management, software management, configuration management, performance management and fault management. The management system of a cellular network handles the neighbouring cell relationships. When there are networks for different wireless technologies and networks of different operators, each network has a management system communicating with other management systems. The management systems have traditionally been optimized (using algorithms) by a radio engineer who, using planning tools, analysis data and experience, sends configuration commands to the network via a GUI. The management system are now getting more and more automated as the size and complexity of the networks increases.

The management system often includes a radio resource management (RRM) functionality, implemented into the controller network element. RRM controls co-channel interference and radio transmission characteristics and involves strategies and algorithms for controlling parameters such as handover criteria. RRM is used to utilize the radio spectrum resources and the network infrastructure as efficiently as possible. It concerns multi-user and multi-cell network capacity issues rather than point-to-point channel capacity. Static RRM involves manual and computer aided, fixed cell and network planning, such as channel allocation, frequency allocation and static handover criteria. Dynamic RRM uses schemes to adaptively adjust the radio network parameters to the traffic load, mobile phone positions and service requirements. Dynamic schemes are considered in cellular networks to minimize expensive manual cell planning etc. to improve the efficiency. Examples of dynamic RRM schemes are dynamic channel allocation (DCA), adaptive filtering and dynamic diversity schemes, such as soft handover in which the channel of the source cell is retained and used for a while in parallel with the channel of the target cell. In this case the connection to the target is established before the connection to the source is broken.

The problem with the existing methods relates to the updating of the neighbouring cells relationship. In the management system, the RRM must have knowledge of the radio resources of the neighbouring cell for the updating. This neighbouring cell information and the nature of its relationships to the local cell is often required to be statically configured on the controller today, via the O&M Management system. In some applications performance counters are used and a set of rules advice the cellular network operator on potential problems with their present network configuration on neighbouring cell relationships.

However, such a management of these neighbouring cells relationship is a complex and time consuming business, added to a cellular network operator's operational expenditures (on-going costs for running the network). There are therefore ongoing discussions in the 3GPP organisation on the need to dynamically create and update neighbouring cells relationship based on measurements received from the mobile phones. However, a problem with pure dynamic management of neighbouring relations is to handle neighbouring relationships appearing and disappearing constantly.

The result is that for cells in areas with periodical traffic, relationships may disappear even though the relation is still valid. In order to avoid their disappearance, the relationships need to be kept configured even though no handovers have occurred during a time to live period. Consequently, there will be network overhead and handover delays due to the need to be constantly recreating and deleting the configuration of these relationships. This could lead to degraded handover performance for these cells. On the other and, in case of a purely static configuration there will be dead relationships that should be removed, and it will take too long time to identify and deal with those relationships. While these dead relationships are not identified and removed they will cause degradation in handover performance.

This requirement for static allocation of neighbouring cells relationship makes the management of the information difficult. Ericsson currently has an application named NOX (neighbouring optimization expert) for optimizing the neighbouring cells relationship list for all cells in a network. It helps the operators to add and remove cells from the lists. NOX that takes events and PM data (Performance Management) and provide reports on the performance of each relationship, can create and delete new static relationships based on data.

There is sometimes a need to decide about a change in the relationships faster than NOX provides. NOX depends on 15 days of PM data before it makes a decision and the controller network element will not remove a neighbouring cell relationship unless requested by the O&M Management system. Faulty neighbouring cell relationships leads to an increased number of failed handovers and dropped calls so it is important to remove them from the network when they are no longer needed.

### SUMMARY

The object of the present invention is to solve the above-mentioned problems by providing an alternative method for deletion of unneeded or unwanted cell relations having a big impact on the network traffic if they remain.

The object is achieved by means of a network element, such as a base station controller, for a cellular network comprising one or more cells being served by at least one transceiver for enabling communication sessions with a mobile cellular terminal. The element comprises communication means adapted for communicating with other network nodes within the same or other networks. The element further comprises register software adapted for creating, configuring and/or removing information about the cell on which a communication session is running and its relationship to at least one neighbouring cell to which a running communication session can be transferred and resource management software adapted for managing the communication session between the transceiver and the terminal. The element is further characterized in that the register software is adapted for creating and/or configuring a counter value on each relationship to a neighbouring cell, which value limits the time or number of events the neighbouring cell can be part of so that when the counter value corresponds to a removal value the relationship is removed.

The object is further achieved by means of a method for handling neighbouring cell relationships for a network element, such as a base station controller in a cellular network, the network comprising one or more cells being served by at least one transceiver for enabling communication sessions with a mobile cellular terminal. The element communicates with other network nodes within the same or other networks. The method comprises the steps of creating, configuring and/or removing information about the cell on which a communication session is running and its relationship to at least one neighbouring cell to which a running communication session can be transferred and managing the communication session between the transceiver and the terminal. The method is further characterized by the steps of creating and/or configuring a counter value for each relationship to a neighbouring cell, which value limits the time or number of events the neighbouring cell can be part of so that when the counter value corresponds to a removal value the relationship is removed. The object is finally achieved by means of a cellular network.

One advantageous effect of the present invention is that it provides a solution for managing dynamic neighbouring cells relationship in a long term evolution (LTE) network. It prevents having a lot of faulty relations defined in the network while still giving the ability to control the extended lifecycle of the important cell relationships. Another advantageous effect is that the present invention limits the potential problem of cell relationships being constantly recreated and deleted by providing a method of applying hysteresis.

### BRIEF DESCRIPTION OF DRAWINGS

The present invention will now be described more in detail with reference to the appended drawings:

FIG. 1 schematically shows a cellular network with a network element according to the present invention.

FIG. 2 schematically shows the network element according to FIG. 1.

FIG. 3 shows the first part of a decision flowchart to decide the creation and/or configuration of a relationship and a counter value.

FIG. 4 shows the second part of the flowchart according to FIG. 3.

FIG. 5 shows a flowchart for the interaction between the network element and network nodes when a relationship and counter value is created.

### DETAILED DESCRIPTION

The network element and the method for carrying out the handling of dynamic cell relations will now be described with reference to an embodiment. The embodiment contains a number of features contributing to the present invention. The embodiment described herein discloses a network element, a method and a cellular network.

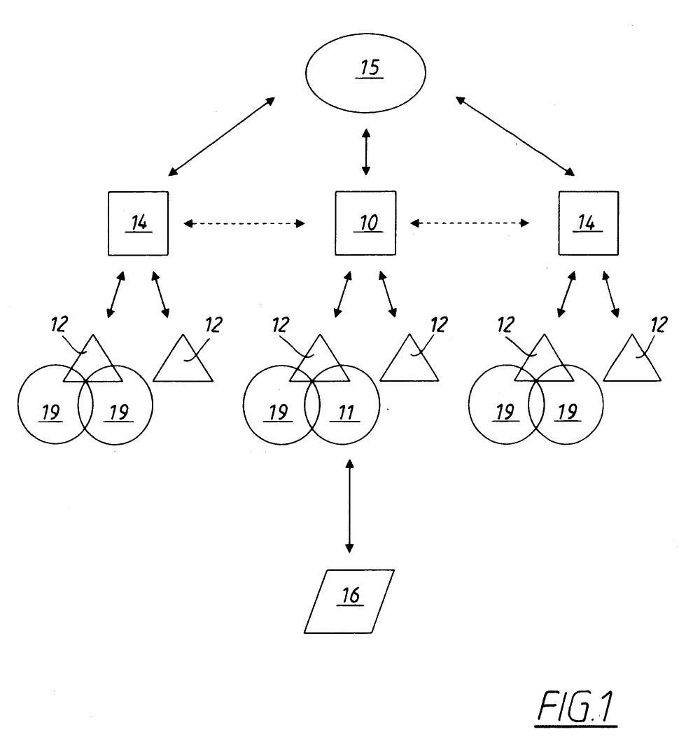

The embodiment comprises a network element 10, such as a base station controller, for a cellular network comprising one or more cells 11, see FIG. 1. These cells are being served by at least one transceiver 12 which enables communication sessions to take place with a mobile cellular terminal, such as a mobile phone. The element may be part of a radio base station or separated there from.

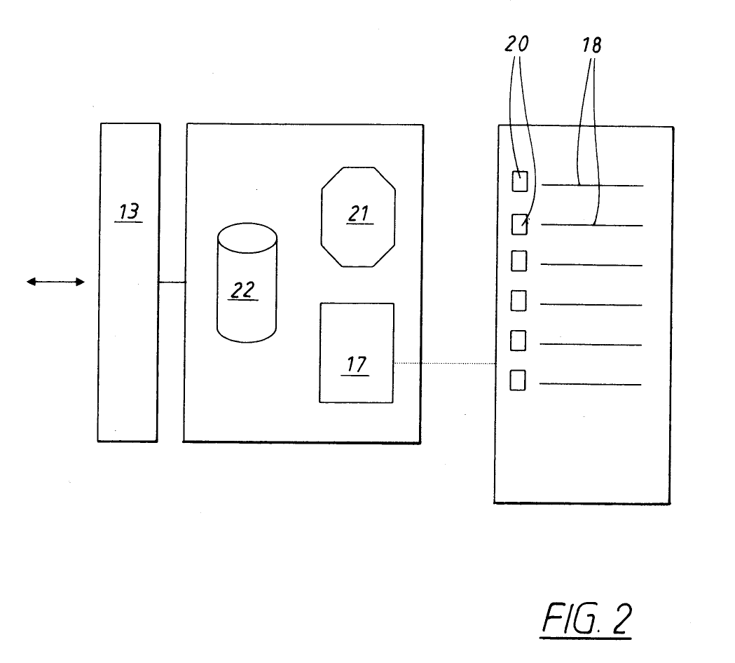

The element comprises communication means 13, see FIG. 2, adapted for communicating with network nodes within the same or other networks. Such network nodes are other base station controllers 14 and transceivers 12 which the element controls and which serves the cells. It is also an Operation and Maintenance Server 15 being part of an Operation and Maintenance Management System. It is also mobile cellular terminals 16. The communication means may for instance be a configuration management interface, such as CORBA/IIOP, SNMP set actions, NETCONF command files or vendor proprietary commands via a shell based command interface.

The network element also comprises, see FIG. 2, register software 17 adapted for creating, configuring and/or removing information about the cell on which a communication session is running and its relationship 18 to at least one neighbouring cell 19 to which a running communication session can be transferred. The element also comprises resource management software 21 adapted for managing the communication session between the transceivers 12 and the terminal 16. The resource management software consists in radio resource management software managing the transfer of the communication sessions from the cell to one of the neighbouring cells. Such software is more and more used to improve the efficiency of a network, see the background part.

The embodiment according to the present invention further comprises the inventive concept of adapting the register software to enable creating and/or configuring a counter value 20 on each relationship to a neighbouring cell, which value limits the time or number of events the neighbouring cell can be part of so that when the counter value corresponds to a removal value the relationship is removed.

The introduction of the counter value gives the advantage that a relationship will not last forever. Instead it will automatically be removed when the counter value corresponds to a removal value. Consequently, this prevents having a lot of faulty relations defined in the network while still giving the ability to control the extended lifecycle of the important cell relationships.

The difference between the counter value and the removal value is an example of a TimeToLive value. In the inventive embodiment of this application, it intends to limit the period of time or number of events that the relationship can experience before it should be discarded. The removal value is a defined value which the counter value reaches by counting up or down, the counting refers to the period of time or number of events. Consequently, the removal value may be zero or a higher or lower level while the counter value approaches the removal value from a higher or lower value.

An event is for instance iterations or transmission that takes place in the network, such as a handover between two cells. The time to live value can be thought of as an upper bound on the time or events that a relationship can exist in a network. The purpose of the value is to avoid a situation in which useless relationships are kept in the network, and such a network eventually becoming swamped by such information.

Regardless of the introduction of the counter value according to the present invention, the Operation and Maintenance System can always support a manual deletion of an existing relationship at any time.

In order to control the creating and/or the configuring of the relationship and the counter value the network element comprises at least one policy 22 defining the set of rules for these actions. The policies are configured by the network operator in the Operation and Maintenance system and sent to the network element. The policy can as an alternative be configured directly on the network element. However, using the O&M System allow for consistency of policies across a number of network elements.

The method for handling neighbouring cell relationships for a network element will now be described. The element is for instance a base station controller in a cellular network, the network comprising one or more cells being served by at least one transceiver for enabling communication sessions with a mobile cellular terminal. The element communicates with other network nodes within the same or other networks by means described earlier. The method comprises the steps of:
creating, configuring and/or removing information about the cell on which a communication session is running and its relationship to at least one neighbouring cell to which a running communication session can be transferred,
managing the communication session between the transceiver and the terminal.

The further inventive step according to the present invention is the creation and/or configuring of a counter value for each relationship to a neighbouring cell. The value limits the time or number of events the neighbouring cell can be part of so that when the counter value corresponds to a removal value the relationship is removed.

The advantage is that the introduction of the counter value makes sure that the relationship will not last forever. Instead it will automatically be removed when the counter value corresponds to the removal value. Consequently, this prevents having a lot of faulty relations defined in the network while still giving the ability to control the extended lifecycle of the important cell relationships.

The removal value is a defined value which the counter value reaches by counting up or down, the counting refers to the period of time or number of events. Consequently, the removal value may be zero or a higher or lower level while the counter value approaches the removal value from a higher or lower value. The difference between the counter value and the removal value is an example of a TimetoLive value.

An event is for instance iterations or transmission that takes place in the network, such as a handover between two cells. Regardless of the introduction of the counter value, the Operation and Maintenance System can always support a manual deletion of an existing relationship at any time.

The relationship and the counter value are created and/or configured based on a set of rules of at least one policy. The policy for these activities defines how they should be made, and depending on how the activities are triggered, the counter value will be set to different values. The policies are configured by the network operator in the Operation and Maintenance system and sent to the network element via the communication means.

If the O&M Management Server 15 monitors a heavy use or a specific behaviour for a particular relationship an update of the counter value is triggered. The value is then changed so that the relationship will last longer. On the other hand, if the server monitors that the relationship is unused or infrequently used the counter value is changed so that the relationship will last shorter. The counter value may even be set to the removal value, which means the relationship will be removed.

The counter value is decreased or increased (counting up or down) continuously, the change being activated by a PM counter, event and/or alarm. The value can also be changed dynamically on the network element by introducing a policy that allows this.

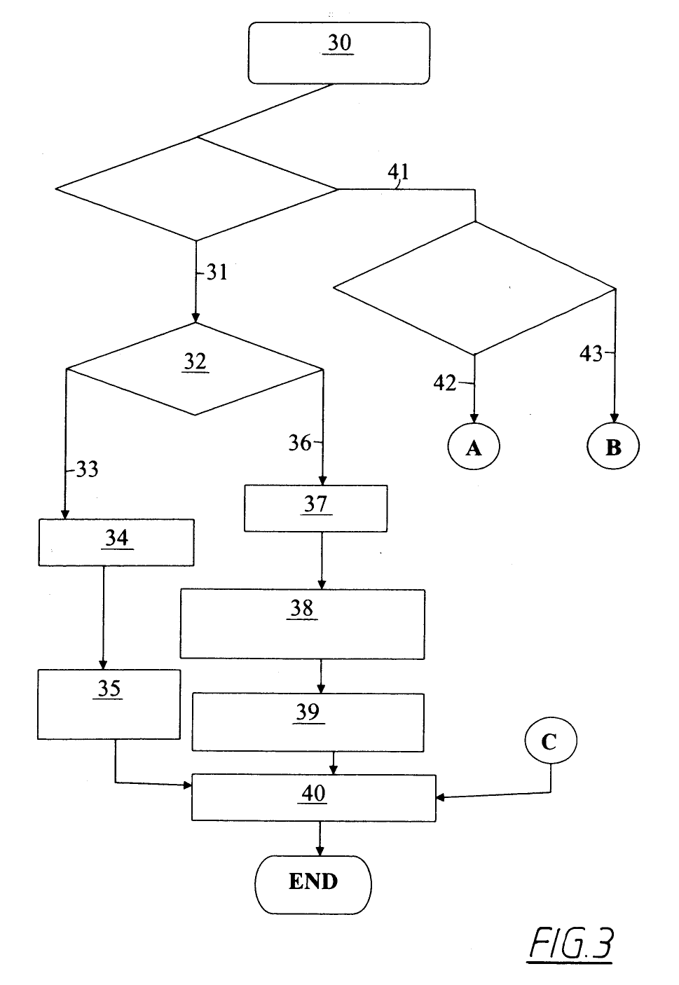

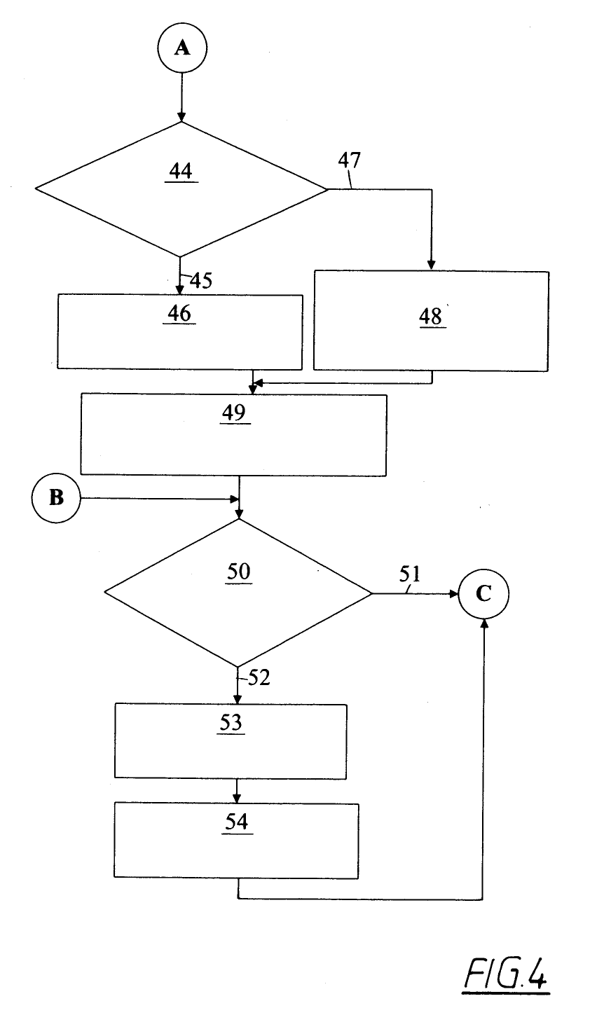

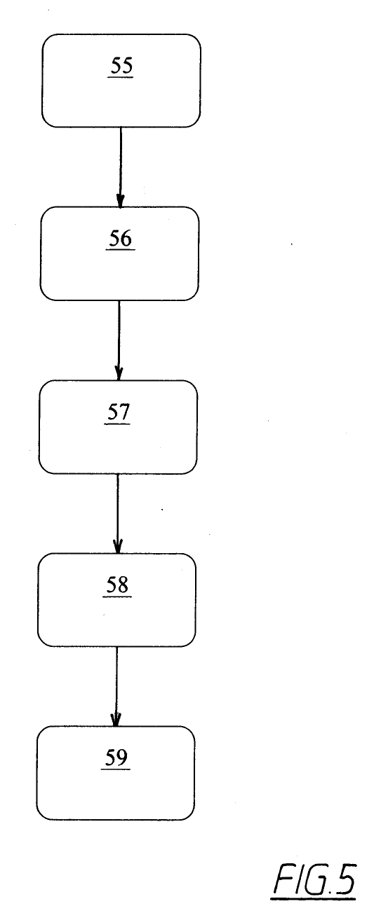

The creation and/or configuration of the relationship and the counter value will now be described with reference to FIGS. 3 and 4. How the network handles the creation and configuration will be described after in relation to FIG. 5. The relationship and the counter value is created and/or configured by the network element. When this is done (the element informs the O&M System) a policy configuration is issued in the O&M System and on activation the system will use a CM management protocol to create relationships in the network element and the other element nodes containing cells having the relationship.

In one example, see FIG. 3, the creation and/or configuration policy is triggered 30 when the network operator manually defines 31 a new relationship. In that case, the creation and/or configuration comprise the steps of:
defining if the relationship should be static 32,
if the answer is YES 33 set the counter value so that it indicates that the relationship should last forever 34, and then issuing a configuration 35 to indicate that no further actions needs to be taken,
if the answer is NO 36 set the counter value to a default value enabling counting down 37, define monitors and/or triggers for the update of the counter value (for example specify PM counters, events and alarms) 38 and then issuing a configuration that indicates the actions applicable by the element and each network node managing a neighbouring cell having a relationship 39,
the configuration being sent to the network element and the network node or nodes managing a neighbouring cell having a relationship 40

The operator cannot manually configure a relationship without associating it to an existing policy on the network element or defining a new policy, with the one exception being the case where the operator creates a totally static relationship.

When the operator manually defines a new relationship that is static (i.e time to live counter does not expire), the O&M system will warn the operator that this relationship will never be dynamically removed if defined in this way and if or, when this relationship is no longer valid it may potentially cause problems. The O&M System health check shall always flag these relations with warning when a health check is executed.

In another example, see FIGS. 3 and 4, the creation and/or configuration policy is triggered 30 by a list defining new geographical neighbouring cell or cells or by a mobile cellular terminal measurement report indicating neighbouring cell or cells. This means that the relationship will not be manually configured by the network operator 41. In one case it is not allowed that the creation and/or configuration is made by the network element communication with a network node controlling the neighbouring cell or cells 43. In that case process of defining if a relationship can be based on a mobile cellular terminal measurement report will be executed, see B.

In another case it is allowed that the creation and/or configuration is made by the network element communicating with a network node controlling the neighbouring cell or cells 42. The creation and/or configuration then comprising the steps of:
defining if the transport layer supports auto-discovery of the network node for neighbouring cell or cells 44,
if the answer is YES 45 issuing a configuration that indicates that the network element should query the network node or nodes for potential relationships 46,
if the answer is NO 47 issuing a configuration that indicates the IP address of the network node or nodes to query for potential relationships 48,
creating configuration information for the monitoring of communication sessions between the element and the network node or nodes and the triggering for counter value updating 49.

In relation to the example when the creation and/or configuration policy is triggered 30 by a list defining new geographical neighbouring cell or cells or by a mobile cellular terminal measurement report indicating neighbouring cell or cells 41, the further steps are made:
defining if a relationship can be based on a mobile cellular terminal measurement report 50,
if the answer is NO 51 the configuration being sent to the network element and the network node or nodes managing a neighbouring cell or cells 40,
if the answer is YES 52 creating configuration information for the monitoring of communication sessions between the element and the network node or nodes managing a neighbouring cell or cells and the triggering for counter value updating and that they should use the measurement report 53
issuing a configuration that indicates that the network element and the network node or nodes should use the measurement reports, configuring the monitoring and triggering 54 and sending the configuration to the network element and the network node or nodes 40.

How the network handles the creation and configuration will now be described in relation to FIG. 5. When the creation and/or configuration of the relationship and the counter value is made 55 the following steps are made:
sending (made by the network element) configuration information to at least one network node, the node being the Operation and Maintenance Server, about the created or configured relationship and counter value 56,
a communication link is created between the network element managing the cell involved in the communication session and the network node or nodes managing the neighbouring cell or cells 57 by issuing a configuration request to the network element and the network node or nodes managing a neighbouring cell 58,
an Operation and Maintenance System starts monitoring the traffic through the communication link via PM counters, events and/or alarms 59.

The counter value is then updated when at certain conditions for the communication traffic is triggered by the system.

The communication link between the network element and another network node can be created directly between these two in a LTE. In WCDMA, the network element and network node is a radio network controller. For LTE, there are two ways to create this link. If the inter network element protocol supports self configuration, the O&M server will provide the authentication support required to allow the network element setup a connection to the node. If dynamic configuration between the network element and the node is not supported the O&M Server shall identify the changes needed and issue configuration requests to both the network element and the node to set up the signalling link between them.

The present invention also relates to a cellular network comprising one or more local cells being served by at least one transceiver, the network comprising a network element and in which the new method for handling neighbouring cells is executed. The network is a mobile phone network, such as GSM or UMTS. The network nodes and the element forms parts of the cellular network and/or a management system. At least one network node is an Operation and Maintenance Server communicating with the network element via a configuration management interface.

1. Network Element, such as a base station controller, for a cellular network comprising one or more cells being served by at least one transceiver for enabling communication sessions with a mobile cellular terminal, the element comprising communication means adapted for communicating with other network nodes within the same or other networks, the element further comprising:
register software adapted for creating, configuring and/or removing information about the cell on which a communication session is running and its relationship to at least one neighbouring cell to which a running communication session can be transferred; and
resource management software adapted for managing the communication session between the transceiver and the terminal,
wherein:
the register software is further adapted for creating and/or configuring a counter value on each relationship to a neighbouring cell, which value limits the time or number of events the neighbouring cell can be part of so that when the counter value corresponds to a removal value the relationship is removed.

2. (canceled)

3. Network element according to claim 1 wherein the network element further comprising at least one policy defining the set of rules for the creating, configuring and/or removing of relationship to the neighbouring cell or cells.

4. Network element according to claim 1 wherein the network element further comprising at least one policy defining the set of rules for creating and/or configuring the counter value.

5. Network element according to claim 1 wherein the resource management software consist in radio resource management software managing the transfer of the communication sessions from the cell to one of the neighbouring cells.

6. Network element according to claim 1 wherein the counter value consist in a time-to-live counter value.

7. (canceled)

8. Network element according to claim 1 wherein the communication means comprises a configuration management interface.

9-11. (canceled)

12. Method for handling neighbouring cell relationships for a network element, such as a base station controller in a cellular network, the network comprising one or more cells being served by at least one transceiver for enabling communication sessions with a mobile cellular terminal, the element communicating with other network nodes within the same or other networks, the method comprising the steps of:
creating, configuring and/or removing information about the cell on which a communication session is running and its relationship to at least one neighbouring cell to which a running communication session can be transferred,
managing the communication session between the transceiver and the terminal, and
creating and/or configuring a counter value for each relationship to a neighbouring cell, which value limits the time or number of events the neighbouring cell can be part of so that when the counter value corresponds to a removal value the relationship is removed.

13. Method according to claim 12 wherein the counter value is counted up or down to reach the removal value being a defined value.

14. Method according to claim 12 wherein the relationship and the counter value is created and/or configured based on a set of rules of at least one policy.

15. Method according to claim 14 wherein the policy is configured by the network operator externally from the network element and sent to the element.

16. Method according to claim 12 wherein the counter value is changed if the relationship is heavily used or exhibits a specific behaviour so that the relationship will last longer.

17. Method according to claim 12 wherein the counter value is changed if the relationship is unused or infrequently used so that the relationship will last shorter.

18. Method according to claim 12 wherein the counter value is decreased continuously, a decrease being activated by a PM counter, event and/or alarm.

19. Method according to claim 12 wherein the creation and/or configuration policy for the relationship and the counter value is triggered by the network operator manually defining a new relationship.

20. Method according to claim 19 wherein the creation and/or configuration policy triggered by the manually defined relationship comprises the steps of:
defining if the relationship should be static,
if the answer is YES set the counter value so that it indicates that the relationship should last forever, and then issuing a configuration to indicate that no further actions needs to be taken,
if the answer is NO set the counter value to a default value enabling counting down, define monitors and/or triggers for the update of the counter value and then issuing a configuration that indicates the actions applicable by the element and each network node managing a neighbouring cell having a relationship,
the configuration being sent to the network element and the network node or nodes managing a neighbouring cell or cells having a relationship.

21. Method according to claim 12 wherein the creation and/or configuration policy for the relationship and the counter value is triggered by a list defining new geographical neighbouring cell or cells or by a mobile cellular terminal measurement report indicating neighbouring cell or cells.

22. Method according to claim 21 wherein the creation and/or configuration is not allowed by the network element communication with a network node or nodes managing neighbouring cell or cells.

23. Method according to claim 21 wherein the creation and/or configuration is made by the network element communicating with a node or nodes managing a neighbouring cell or cells, the creation and/or configuration comprising the steps of:
defining if the transport layer supports auto-discovery of node or nodes managing a neighbouring cell or cells,
if the answer is YES issuing a configuration that indicates that the network element should query the node or nodes for potential relationships,
if the answer is NO issuing a configuration that indicates the IP address of the network node or nodes to query for potential relationships,
creating configuration information for the monitoring of communication sessions between the element and the node or nodes and the triggering for counter value updating.

24. Method according to claim 22 wherein the creation and/or configuration comprises the steps of:
defining if a relationship can be based on a mobile cellular terminal measurement report,
if the answer is NO the configuration being sent to the network element and the node or nodes managing a neighbouring cell or cells,
if the answer is YES creating configuration information for the monitoring of communication sessions between the element and network node or nodes managing a neighbouring cell or cells and the triggering for counter value updating and that they should use the measurement report,
issuing a configuration that indicates that the network element and the network node or nodes should use the measurement reports, configuring the monitoring and triggering and sending the configuration to the network element and the network node or nodes.

25. Method according to claim 19 wherein when a creation and/or configuration of the relationship and the counter value is made the following steps are made:
sending configuration information to at least one network node about the created or configured relationship and counter value,
a communication link is created between the network element managing the cell involved in the communication session and the network node or nodes managing the neighbouring cell or cells by issuing a configuration request to the network element and the network node or nodes managing a neighbouring cell, and
an Operation and Maintenance System starts monitoring the traffic through the communication link via PM counters, events and/or alarms.

26. (canceled)

27. A cellular network comprising one or more local cells being served by at least one transceiver, the network comprising a network element, such as a base station controller, for a cellular network comprising one or more cells being served by at least one transceiver for enabling communication sessions with a mobile cellular terminal, the element comprising communication means adapted for communicating with other network nodes within the same or other networks, the element further comprising:
register software adapted for creating, configuring and/or removing information about the cell on which a communication session is running and its relationship to at least one neighbouring cell to which a running communication session can be transferred, and
resource management software adapted for managing the communication session between the transceiver and the terminal, wherein
the register software is further adapted for creating and/or configuring a counter value on each relationship to a neighbouring cell, which value limits the time or number of events the neighbouring cell can be part of so that when the counter value corresponds to a removal value the relationship is removed.

28. (canceled)

29. A cellular network according to claim 27 wherein the network node or nodes and the element forms parts of the cellular network and/or a management system.

30. A cellular network according to claim 29 wherein at least one network node is an Operation and Maintenance Server communicating with the network element via a configuration management interface.
